(19) United States
(12) Patent Application Publication
(10) Pub. No.: US 2014/0192554 A1
(43) Pub. Date: Jul. 10, 2014

(54) ILLUMINATION DEVICE AND DISPLAY DEVICE PROVIDED THEREWITH

(71) Applicant: Masatoshi Tomomasa, Osaka (JP)

(72) Inventor: Masatoshi Tomomasa, Osaka (JP)

(73) Assignee: Sharp KabushikiI Kaisha, Osaka (JP)

(21) Appl. No.: 14/238,782

(22) PCT Filed: Aug. 17, 2012
(86) PCT No.: PCT/JP2012/070892

§ 371 Date: Feb. 13, 2014

(30) Foreign Application Priority Data
Aug. 18, 2011 (JP) 2011-179116

(51) Int. Cl. F21V 8/00

(52) U.S. Cl. CPC G02B 6/0088
USPC 362/606; 362/634; 362/613

(57) ABSTRACT

Provided is an illumination device that can suppress uneven brightness in a member to be illuminated caused by the positioning structure of the light guide plate. An illumination device (10) includes light sources (11), a light guide plate (13) that guides light from the light sources, and positioning members (14) that position the light guide plate. The light guide plate includes a light-exiting surface (13a) where light exits towards a display panel (2), and a rear surface (13b) arranged on the side opposite to the light-exiting surface. Recessed portions (13e) having a depth that does not reach the light-exiting surface are formed in edges of the rear surface of the light guide plate, and the positioning members engage the recessed portions.

### TECHNICAL FIELD

The present invention relates to an illumination device and a display device provided therewith, and particularly relates to an illumination device having a light guide plate that guides light from a light source and a display device provided therewith.

### BACKGROUND ART

A liquid crystal display device (a display device) equipped with a non light emitting display panel (a member to be illuminated) typically has a backlight device (an illumination device) that illuminates the display panel. A backlight device provided with a plurality of LEDs (light emitting diodes, which are light sources) and a light guide plate that guides light from these LEDs is known as such a backlight device.

FIGS. 8 to 12 are views of an example of a conventional display device configuration provided with LEDs and a light guide plate. As shown in FIG. 8, a display device 1001 includes a display panel (a member to be illuminated) 1002, a backlight device 1010 that illuminates the display panel 1002, and a metal chassis 1020 that houses these. The backlight device 1010 includes a plurality of LEDs (light sources) 1011 (see FIG. 9), a mounting substrate 1012 whereon the LEDs 1011 are mounted (see FIG. 9), a light guide plate 1013 that guides light from the LEDs 1011, positioning members 1014 that position the light guide plate 1013, a plurality of optical sheets 1015 arranged on a light-exiting surface 1013a of the light guide plate 1013, and a reflective sheet 1016 arranged on a rear surface 1013b of the light guide plate 1013. FIG. 9 shows the example of the conventional display device 1001 in FIG. 8 without a rear surface part 1020a (see FIG. 8) of the chassis 1020 and the reflective sheet 1016.

The light guide plate 1013 has the light-exiting surface 1013a, which is the largest surface of the light guide plate, disposed on the side facing the display panel 1002, the rear surface 1013b disposed on the side opposite to the light-exiting surface 1013a, light-entering faces 1013c arranged facing the LEDs 1011 (see FIG. 9), and side faces 1013d extending in a direction (B direction) that intersects the light-entering faces 1013c. The light-exiting surface 1013a is formed perpendicular to the light-entering faces 1013c. As shown in FIGS. 9 to 11, cut-out parts 1013e that reach from the light-exiting surface 1013a to the rear surface 1013b are formed in the side faces 1013d. These cut-out parts 1013e each have an inner face 1013f parallel to the side faces 1013d and inner faces 1013g parallel to the light-entering faces 1013c. The positioning members 1014 are each set inside the respective cut-out parts 1013e to restrict movement in the plane direction of the light guide plate 1013.

As shown in FIGS. 8 and 9, ribs 1017 are disposed on the front side of the light guide plate 1013 so as to extend in the B direction in the vicinity of the side faces 1013d of the light guide plate 1013. As shown in FIG. 9, the ribs 1017 are formed in a shape with the middle thereof cut out in order to avoid the positioning members 1014.

In this display device 1001, the light emitted from the LEDs 1011 enters the light-entering faces 1013c of the light guide plate 1013 and exits from the light-exiting surface 1013a towards the display panel 1002.

A display device provided with a light guide plate that guides light from a light source is disclosed in Patent Document 1, for example. In Patent Document 1, second support members are disposed so as to surround the light guide plate and these second support members restrict movement of the light guide plate.

### RELATED ART DOCUMENT

### Patent Document

Patent Document 1: Japanese Patent Application Laid-Open Publication No. 2010-80295

### SUMMARY OF THE INVENTION

### Problems to be Solved by the Invention

In the display device 1001 of the conventional example, however, the light that enters the light guide plate 1013 and then reaches the cut-out parts 1013e leaks from the cut-out parts 1013e (from the inner faces 1013f and 1013g) to outside of the light guide plate 1013. As shown in FIG. 11, a portion of the light that is leaked from the cut-out parts 1013e is directly incident on an end face of the display panel 1002. Thus, as shown in FIG. 12, the brightness of the display panel 1002 will be greater at sections S1001 near the cut-out parts 1013e, resulting in uneven brightness in the display panel.

The present invention was made to solve the above-mentioned problem and aims at providing an illumination device capable of suppressing uneven brightness of a member to be illuminated caused by a positioning structure for the light guide plate, and a display device provided therewith.

### Means for Solving the Problems

To achieve the above-mentioned goals, an illumination device of the present invention includes light sources; a light guide plate guiding light from the light sources; and a positioning member positioning the light guide plate, wherein the light guide plate includes a light-exiting surface where light exits towards a member to be illuminated, and a rear surface arranged on a side opposite to the light-exiting surface, wherein a recessed portion is formed in an edge of the rear surface of the light guide plate, the recessed portion having a depth that does not reach the light-exiting surface, and wherein the positioning member engages the recessed portion.

In this illumination device, as described above, a recessed portion having a depth that does not reach the light-exiting surface is formed in an edge of the rear surface of the light guide plate. Due to this, if light that has entered the light guide plate and reached the recessed portion leaks to outside of the light guide plate, this light will then leak to the rear surface side (the side opposite to the member to be illuminated) of the light guide plate. Therefore, light that has leaked from the recessed portion can be prevented from being directly incident on the end face of the member to be illuminated. This makes it possible to suppress an increase in brightness in portions of the member to be illuminated near the recessed portion; therefore, uneven brightness in the member to be illuminated caused by the positioning structure of the light guide plate can be suppressed.

Furthermore, by forming the recessed portion so as not to reach the light-exiting surface, the area of the inner face in the recessed portion can be smaller than if the recessed portion were to reach the light-exiting surface. This makes it possible to reduce the amount of light leaked to outside of the light guide plate.

In the above-mentioned illumination device, it is preferable that the rear surface of the light guide plate have four sides, the recessed portion be formed in a side of the four sides, this side extending in a first direction, and a length of the recessed portion in the first direction be shorter than a length of the side extending in the first direction. In other words, the recessed portion is formed in a portion of the side. If configured as such, the recessed portion has a face extending in the direction intersecting the first direction, rather than being formed from end to end in the side extending in the first direction. This makes it possible to restrict movement of the light guide plate in the first direction. Furthermore, by forming the recessed portion in a portion of the side, the recessed portion can be made smaller; thus, the positioning member can be made smaller.

In the above-mentioned illumination device, it is preferable that the rear surface of the light guide plate have four sides, the light sources be arranged along a prescribed side of the four sides, and the recessed portion be formed in a side that intersects the prescribed side of the four sides. In this way, if the recessed portion is formed in the side of the four sides that intersects with the side where the light sources are arranged, then the amount of light leaked from the recessed portion is susceptible to increase and uneven brightness is likely to occur. Therefore, the present invention is particularly useful when the recessed portion is formed in a side of the four sides that intersects a side (a prescribed side) where the light sources are arranged.

In the above-mentioned illumination device, it is preferable that the rear surface of the light guide plate have four sides, and the recessed portion be formed in at least two sides facing each other of the four sides. If configured as such, the light guide plate can be positioned with high accuracy.

In the above-mentioned illumination device, it is preferable that the rear surface of the light guide plate have four sides, the recessed portion be formed in a side of the four sides, this side extending in a first direction, and the recessed portion include a first inner face extending in the first direction, a second inner face extending in a second direction that intersects the first direction, and a bottom surface intersecting the first inner face and the second inner face. If configured as such, it is possible to restrict movement of the light guide plate in the direction perpendicular to the first inner face, the direction perpendicular to the second inner face, and the direction perpendicular to the bottom surface.

In the illumination device in which the recessed portion includes the above-mentioned first inner face, second inner face, and bottom surface, it is preferable that the light sources be arrayed along a prescribed direction, and a light-blocking be disposed on one of the first inner face and the second inner face that is parallel to an array direction of the light sources. If configured as such, light leaking from the recessed portion can be suppressed, and thus, uneven brightness occurring in the member to be illuminated can be suppressed.

In the illumination device in which the above-mentioned light sources are arranged along a prescribed side of the four side, it is preferable that the light sources be arranged along at least two sides facing each other of the four sides, the recessed portion be formed in a side intersecting the two sides facing each other of the four sides, and the recessed portion be formed in a middle of the side intersecting the two sides facing each other. If configured as such, the distance from the two sides facing each other to the recessed portion can be made substantially equal. Due to this, when the light guide plate expands due to heat, the amount of movement of the two sides facing each other can be made substantially equal.

In the above-mentioned illumination device, it is preferable that the rear surface of the light guide plate have four sides, the recessed portion be formed in a side of the four sides, this side extending in a first direction, a light-blocking member be disposed on an edge of the light-exiting surface of the light guide plate in a vicinity of the side extending in the first direction, the light-blocking member extending in this first direction, and in a plan view the light-blocking member be arranged so as to overlap the positioning member. If configured as such, light that has leaked from the recessed portion, passed along the light guide plate, and reached a space above the light-exiting surface can be blocked by the light-blocking member. Due to this, light that has leaked from the recessed portion being incident on the member to be illuminated can be further suppressed; therefore, uneven brightness in the member to be illuminated can be further suppressed.

A display device of the present invention includes the illumination device having the configurations described above, and a display panel illuminated by the illumination device. If configured as such, a display device can be achieved in which it is possible to suppress uneven brightness in the member to be illuminated caused by the positioning structure for the light guide plate.

In the above-mentioned display device, when a chassis having light-blocking characteristics is not arranged between the display panel and light guide plate, uneven brightness in the member to be illuminated caused by light leakage is likely to occur. The present invention is particularly useful in such a case that a chassis is arranged between the display panel and light guide plate.

### Effects of the Invention

As described above, according to the present invention an illumination device capable of suppressing uneven brightness in a member to be illuminated caused by a positioning structure for the light guide plate and a display device provided therewith can be obtained with ease.

### BRIEF DESCRIPTION OF THE DRAWINGS

FIG. 1 is a cross-sectional view of a structure of a display device according to Embodiment 1 of the present invention.

FIG. 2 is a rear view of the structure of the display device shown in FIG. 1 according to Embodiment 1 of the present invention.

FIG. 3 is a perspective view of the structure shown in FIG. 1 around a recessed portion of a light guide plate of Embodiment 1 of the present invention, as viewed from the rear surface.

FIG. 4 is a rear view of the structure shown in FIG. 1 around the recessed portion of the light guide plate of Embodiment 1 of the present invention.

FIG. 5 is a cross-sectional view of the structure of the display device shown in FIG. 1 according to Embodiment 1 of the present invention.

FIG. 6 is a perspective view of a structure around a recessed portion of a light guide plate of Embodiment 2 of the present invention, as viewed from the rear surface.

FIG. 7 is a rear view of a structure of a display device according to Embodiment 3 of the present invention.

FIG. 8 is a cross-sectional view of an example of a structure of a conventional display device.

FIG. 9 is a rear view of the example of the structure of the conventional display device in FIG. 8.

FIG. 10 is a perspective view of the example of the conventional structure shown in FIG. 8 near a cut-out part of a light guide plate, as viewed from the rear surface.

FIG. 11 is a cross-sectional view of the example of the structure of the conventional display device in FIG. 8.

FIG. 12 is a plan view of the example of the structure of the conventional display device in FIG. 8.

### DETAILED DESCRIPTION OF EMBODIMENTS

Embodiments of the present invention will be explained below with reference to the drawings. For clarity, hatching is not used in some cross-sectional views.

### Embodiment 1

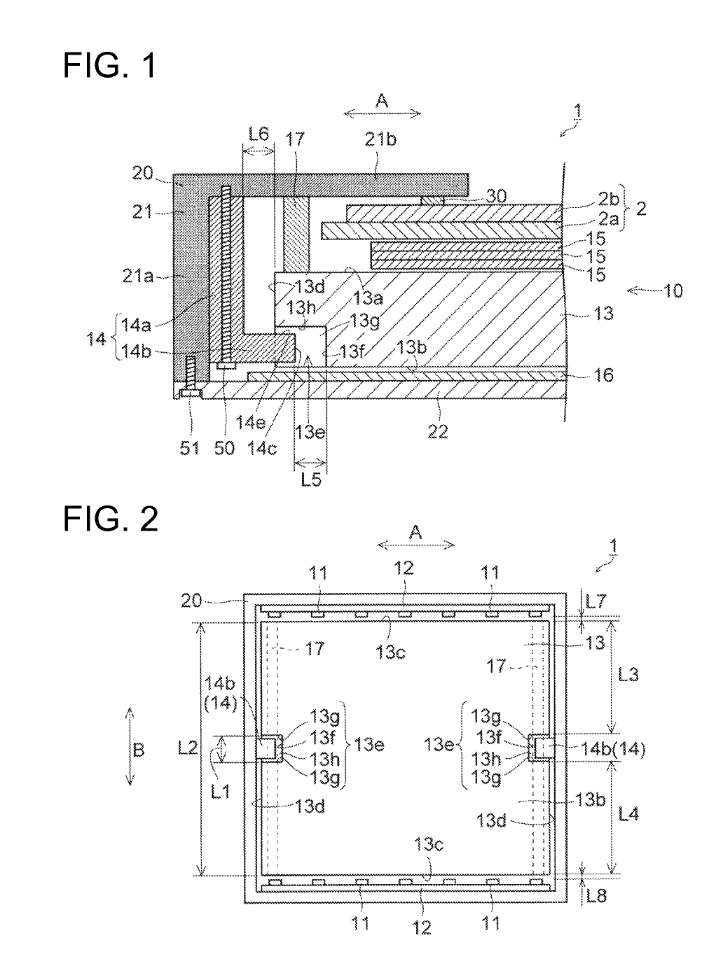

A structure of a display device 1 according to Embodiment 1 of the present invention will be explained below with reference to FIGS. 1 to 5.

The display device 1 according to Embodiment 1 of the present invention is used with television receivers, portable information devices, and the like, for example. As shown in FIG. 1, the display device 1 includes a display panel 2 (a member to be illuminated), an illumination device 10 that is arranged on the rear surface side of the display panel 2 and that illuminates the display panel 2, and a metal chassis 20 that houses these. The “rear surface side” (the bottom side in FIG. 1) in the “rear surface side of the display panel 2” is a directional concept that also applies to other constituting elements.

The display panel 2 is constituted of a liquid crystal display panel and has two glass substrates 2a and 2b that sandwich a liquid crystal layer (not shown) therebetween. A driver IC (integrated circuit) and FPC (flexible printed circuit) (not shown) are mounted on the display panel 2. The display panel 2 displays images by being illuminated by the illumination device 10.

The illumination device 10 is an edge-lit (also called side-lit) backlight device. The illumination device 10 includes a plurality of light sources 11 (see FIG. 2), mounting substrates 12 whereon the plurality of light sources 11 are mounted (see FIG. 2), a light guide plate 13 that guides light from the light sources 11, metal positioning members 14 that position the light guide plate 13, a plurality of optical sheets 15 arranged above a light-exiting surface 13a of the light guide plate 13, and a reflective sheet 16 arranged below a rear surface 13b of the light guide plate 13. FIG. 2 shows a state in which a rear surface part 22, described later, of the chassis 20 and the reflective sheet 16 have been removed.

As shown in FIG. 2, the plurality of light sources 11 are arranged facing light-entering faces 13c, described later, of the light guide plate 13 and are arrayed with prescribed gaps therebetween in the A direction (the direction parallel to the light-entering faces 13c of the light guide plate 13). The light sources 11 are LEDs, for example, and emit white light. The light sources 11 are mounted on the respective mounting substrates 12 by a layer of solder or the like (not shown). The A direction is an example of a “second direction” and “prescribed direction” of the present invention.

As shown in FIGS. 1 and 2, the light guide plate 13 is formed in a flat-plate shape. The light guide plate 13 has the light-exiting surface 13a that is the largest surface of the light guide plate and from which planar light exits towards the display panel 2 (see FIG. 1), the rear surface 13b disposed on the side opposite to the light-exiting surface 13a, the light-entering faces 13c that are arranged facing the light sources 11 and where light emitted from the light sources 11 enters (see FIG. 2), and side faces 13d extending in a direction (B direction) that is orthogonal to (intersects) the light-entering faces 13c. The light guide plate 13 functions to guide light that has entered the light-entering faces 13c and to change the progression direction of the light so that planar light is emitted towards the display panel 2. The B direction is an example of a “first direction” of the present invention.

As shown in FIGS. 1 to 3, recessed portions 13e having a depth that does not reach the light-exiting surface 13a are formed in edges of the rear surface 13b. Specifically, the rear surface 13b is a rectangular shape with four sides, and the recessed portions 13e are respectively formed in two sides (the side faces 13d) extending in the B direction (the first direction) of these four sides. As such, the recessed portions 13e are formed in two opposing sides of the four sides. Meanwhile, of these four sides, the light sources 11 are arranged along the sides (prescribed sides) extending in the A direction. In this way, the light sources 11 are arranged along two opposing sides of these four sides.

As shown in FIG. 2, a length L1 of the recessed portions 13e in the B direction is smaller than a length L2 of the sides (side faces 13d) that extend in the B direction. In other words, the recessed portions 13e are formed as a portion of the sides extending in the B direction. The recessed portions 13e are formed in the center of the sides (side faces 13d) extending in the B direction, and the distances (L3 and L4) from the two sides (the two light-entering faces 13c) extending in the A direction to the recessed portions 13e are equal.

The recessed portions 13e each include an inner face 13f parallel to the side faces 13d, inner faces 13g parallel to the light-entering faces 13c, and a bottom surface 13h parallel to the rear surface 13b (orthogonal to the inner faces 13f and 13g). The recessed portions 13e have a depth that is less than or equal to ½ the thickness of the light guide plate 13, for example.

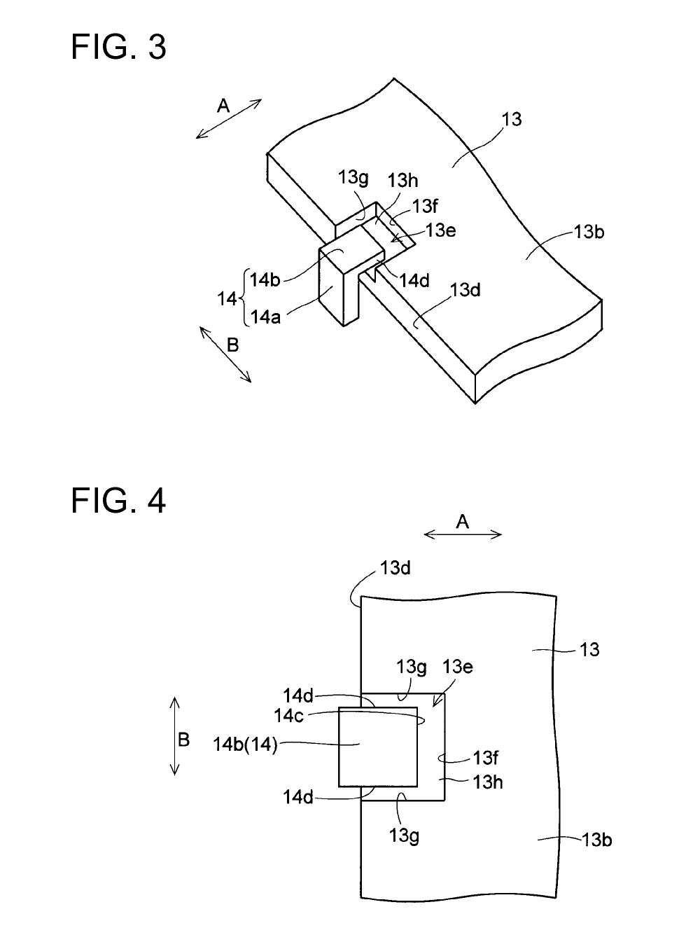

As shown in FIGS. 1 and 3, the positioning member 14 includes a column part 14a extending in the thickness direction of the light guide plate 13 and an engaging part 14b that protrudes from the column part 14a towards the light guide plate 13 and that engages the recessed portion 13e. As shown in FIG. 1, the column part 14a is attached to a front part 21b, described later, of the chassis 20 by a screw 50. The screw 50 is omitted in FIGS. 2 and 3. The column part 14a may be secured to the chassis 20 by an adhesive layer or the like. The engaging part 14b may be secured to the chassis 20 without the column part 14a.

As shown in FIG. 4, the engaging part 14b includes a side face 14c arranged facing the inner face 13f, side faces 14d arranged facing the respective inner faces 13g, and a front surface 14e (see FIG. 1) arranged facing the bottom surface 13h. The side faces 14c and 14d restrict movement in the plane direction (the A direction and B direction) of the light guide plate 13, and the front surface 14e restricts movement in the thickness direction of the light guide plate 13.

As shown in FIG. 1, the side face 14c is arranged from the inner face 13f of the recessed portion 13 with a prescribed distance L5 therebetween, and the column part 14a is arranged from the light guide plate 13 with a prescribed distance L6 therebetween. The distance L5 from the side face 14c to the inner face 13f of the recessed portion 13 and the distance L6 from the column part 14a to the light guide plate 13 are configured in consideration of the rate of thermal expansion. When the light guide plate 13 expands due to heat, the light guide plate 13 is configured so as to not simultaneously abut the two positioning members 14 arranged on both sides in the A direction. This makes it possible to suppress warping of the light guide plate 13. The distance L6 from the column part 14a to the light guide plate 13 may be longer or shorter than the distance L5 from the side face 14c to the inner face 13f of the recessed portion 13. In other words, the engaging part 14b may restrict movement of the light guide plate 13 in the A direction, and the column part 14a may restrict movement of the light guide plate 13 in the A direction.

As shown in FIGS. 1 and 2, ribs 17 (light-blocking members) are disposed on the edges of the light-exiting surface 13a of the light guide plate 13 in the vicinity (the vicinity of the sides extending in the B direction) of the side faces 13d of the light guide plate 13. These ribs 17 are secured to the front part 21b of the chassis 20 and restrict movement in the thickness direction of the light guide plate 13.

The ribs 17 function to block light. In a plan view, the ribs 17 are disposed so as overlap the positioning members 14 and recessed portions 13e and formed so as to extend in the B direction.

There is no plastic chassis that performs holding or light blocking of the display panel 2 between the light guide plate 13 and the display panel 2.

The plurality of optical sheets 15 are a diffusion plate, a prism sheet, a lens sheet, and the like, and function to diffuse light from the light guide plate 13 and concentrate it to a prescribed viewing angle. The diffusion plate, prism sheet, lens sheet, and the like may be provided or not provided as necessary.

The reflective sheet 16 functions to reflect light that has exited from the rear surface 13b of the light guide plate 13 back towards the light guide plate 13.

The chassis 20 includes a frame part 21 and a rear surface part 22 that is secured to the frame part 21 by a screw 51. The frame part 21 is formed so as to have an L-shaped cross-section and includes a side face part 21a covering a side of the display panel 2 and illumination device 10, and a front part 21b covering the front side of the edges of the display panel 2. A sealing member 30 is disposed between the front part 21b of the chassis 20 and the display panel 2.

The display device 1 is assembled in a state in which the top and bottom of the frame part 21 of the chassis 20 are reversed, and the display panel 2, the plurality of optical sheets 15, light guide plate 13, and the like are housed, and the positioning members 14 and rear surface part 22 of the chassis 22 are attached.

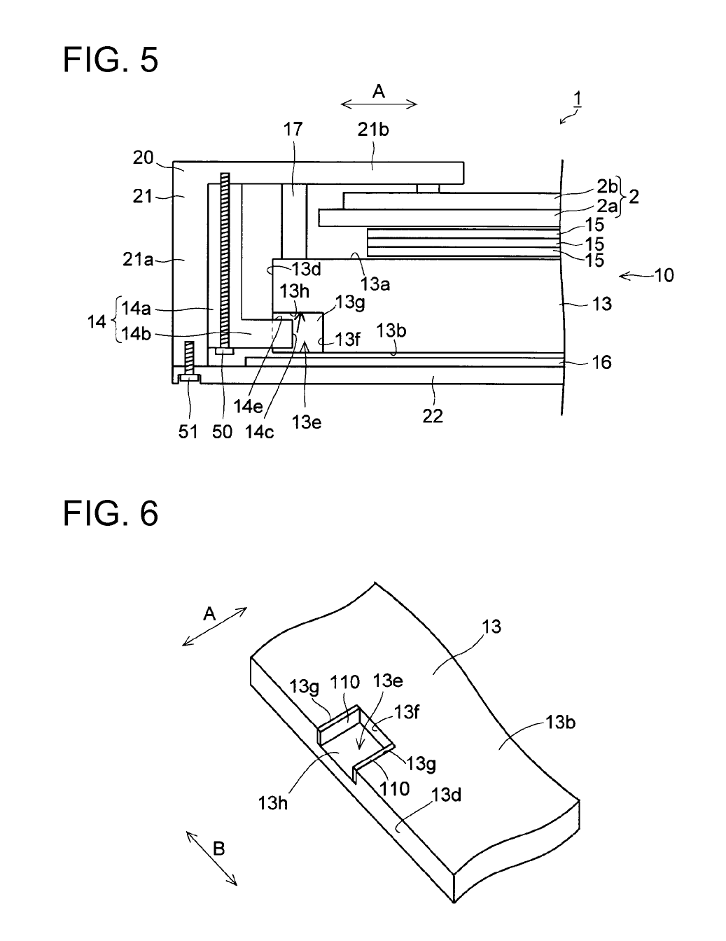

In the present embodiment, as described above, recessed portions 13e that have a depth not reaching the light-exiting surface 13a are formed in the edges of the rear surface 13b of the light guide plate 13. Due to this, if light that has entered the light guide plate 13 and then reached the recessed portions 13e leaks to outside of the light guide plate 13, this light will leak toward the rear surface 13b (the side opposite to the display panel 2) of the light guide plate 13. Therefore, as shown in FIG. 5, light that has leaked from the recessed portions 13e towards the end face of the display panel 2 can be prevented from being directly incident on the end face of the display panel 2. This makes it possible to suppress an increase in brightness in sections of the display panel 2 around the recessed portions 13e; therefore, uneven brightness occurring in the display panel 2 can be suppressed.

Furthermore, by forming the recessed portions 13e so as not to reach the light-exiting surface 13a, the area of the inner faces 13f and 13g of the recessed portions can be made smaller than if the recessed portions 13e reached the light-exiting surface 13a. This makes it possible to reduce the amount of light leaked to outside of the light guide plate 13.

As described above, the length L1 of the recessed portions 13e in the B direction is shorter than the length L2 of the sides (the side faces 13d) of the rear surface 13b of the light guide plate 13 that extend in the B direction. In other words, the recessed portions 13e are formed in a portion of the sides. Due to this, the recessed portions 13e have faces (inner faces 13g) extending in the direction intersecting the B direction, rather than being formed from end to end in the sides extending in the B direction. This makes it possible to restrict movement of the light guide plate 13 in the B direction. By forming the recessed portions 13e in a portion of the sides, the recessed portions 13e can be made smaller; thus, the positioning members 14 can be made smaller.

As described above, among the four sides of the rear surface 13b of the light guide plate 13, if the recessed portions 13e are formed in the sides that are orthogonal to (intersect) the sides where the light sources 11 are arranged, then the amount of light leaking from the recessed portions 13e is susceptible to increase, and uneven brightness is likely to occur. Therefore, the present invention is particularly useful if the recessed portions 13e are formed in the sides that are orthogonal to the sides where the light sources 11 are arranged, among the four sides of the rear surface 13b of the light guide plate 13.

As described above, among the four sides of the rear surface 13b of the light guide plate 13, the recessed portions 13e are formed in two opposing sides. This makes it possible to position the light guide plate 13 with high accuracy.

As described above, the recessed portions 13e each include the inner face 13f extending in the B direction, the inner faces 13g extending in the A direction, and the bottom surface 13h intersecting the inner face 13f and inner faces 13g. This makes it possible to restrict movement of the light guide plate 13 in the A direction, which is perpendicular to the inner face 13f, the B direction, which is perpendicular to the inner faces 13g, and in a direction perpendicular to the bottom surface 13h (the thickness direction of the light guide plate 13).

As described above, among the four sides of the rear surface 13b of the light guide plate 13, the recessed portions 13e are formed in the center of the sides (the side faces 13d) that are orthogonal to the sides where the light sources 11 are arranged. Due to this, it is possible for the distances L3 and L4 from the two sides (the two light-entering faces 13c) where the light sources 11 are arranged to the recessed portions 13e to be substantially equal. Therefore, when the light guide plate 13 expands due to heat, the amount of movement of these two sides where the light sources 11 are arranged (the two light-entering faces 13c) in the B direction can be substantially equal. This makes it possible to suppress a scenario in which only one of the distances L7 and L8 (see FIG. 2) from the light-entering faces 13c of the light guide plate 13 to the light sources 11 changes markedly.

As described above, the ribs 17 extending in the B direction are disposed on the edges of the light-exiting surface 13a of the light guide plate 13 in the vicinity of the sides (side faces 13d) extending in the B direction. In a plan view, the ribs 17 overlap the positioning members 14. Due to this, the ribs 17 can block light that has leaked from the recessed portions 13e, passed along the light guide plate 13, and then entered a space above the light-entering face 13a. As a result, it is possible to suppress light that has leaked from the recessed portions 13e being incident on the display panel 2, and thus, uneven brightness in the display panel 2 can be suppressed. Needless to say, light that leaks from locations other than the recessed portions 13e (the side faces 13d, for example) of the light guide plate 13, passes through the side of the light guide plate 13, and then reaches a space above the light-entering face 13a, can also be blocked by the ribs 17. This can also suppress light that has leaked from locations other than the recessed portions 13e of the light guide plate 13 being incident on the display panel 2.

As described above, if a plastic chassis or the like having light-blocking characteristics is not arranged between the display panel 2 and the light guide plate 13, uneven brightness in the display panel 2 caused by light leakage is susceptible to occurring. Therefore, the present invention is particular useful when a plastic chassis or the like is not arranged between the display panel 2 and the light guide plate 13.

### Embodiment 2

As shown in FIG. 6, a display device of Embodiment 2 of the present invention has light-blocking layers 110 attached to faces (inner faces 13g) of a recessed portion 13e parallel to the array direction (the A direction) of light sources 11. This light-blocking layer 110 has a thickness of approximately 0.1 mm and is made of black nylon tape, for example.

Other structures in Embodiment 2 are similar to Embodiment 1 described above.

In the present embodiment as described above, of the inner faces 13f and 13g of the recessed portion 13e, the light-blocking layers 110 are disposed on the faces (inner faces 13g) of the recessed portion 13e that are parallel to the array direction of the light sources 11. As a result, light can be further suppressed from leaking from the recessed portions 13e, and thus, uneven brightness in the display panel 2 can be further suppressed. The inner faces 13g (the faces parallel to the array direction of the light sources 11) are more susceptible to light leakage than the inner face 13f (the face perpendicular to the array direction of the light sources 11); therefore, providing the light-blocking layers 110 on the inner faces 13g is particularly useful.

The recessed portions 13e are formed so as not to reach a light-exiting surface 13a, and thus, the depth of the recessed portions 13e is less than if the recessed portions 13e were formed reaching the light-exiting surface 13a. This makes it easy to be able to attach the light-blocking layers 110 to the inner faces 13g without bending, wrinkles, or the like occurring. The light-blocking layers 110 do not stick out from the light-exiting surface 13a; thus, optical sheets 15 will not attach to the light-blocking layers 110 and bend.

Other effects in Embodiment 2 are similar to Embodiment 1 described above.

### Embodiment 3

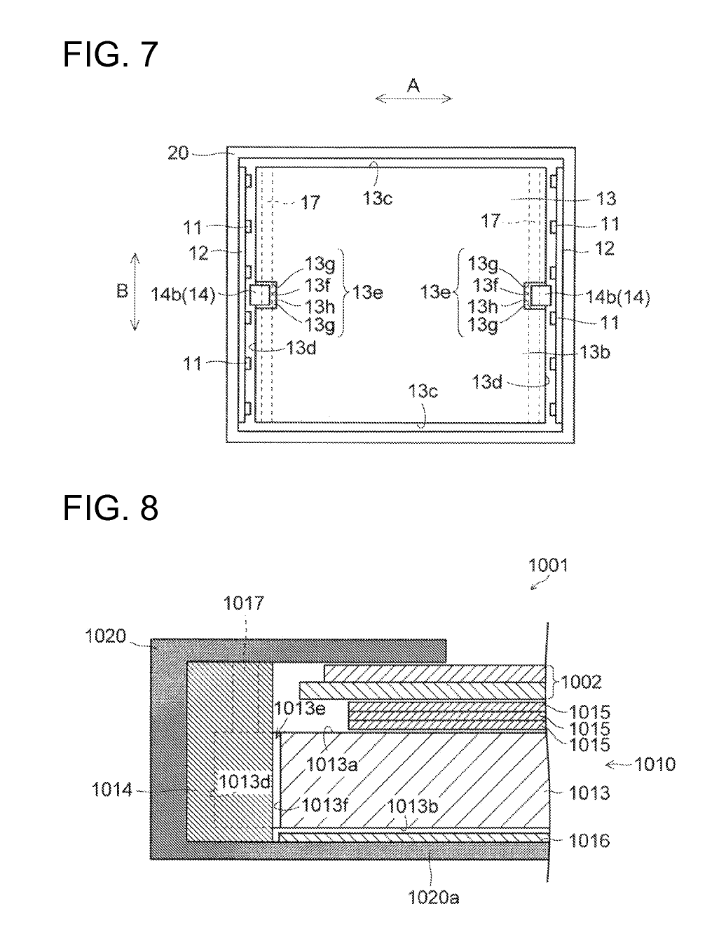

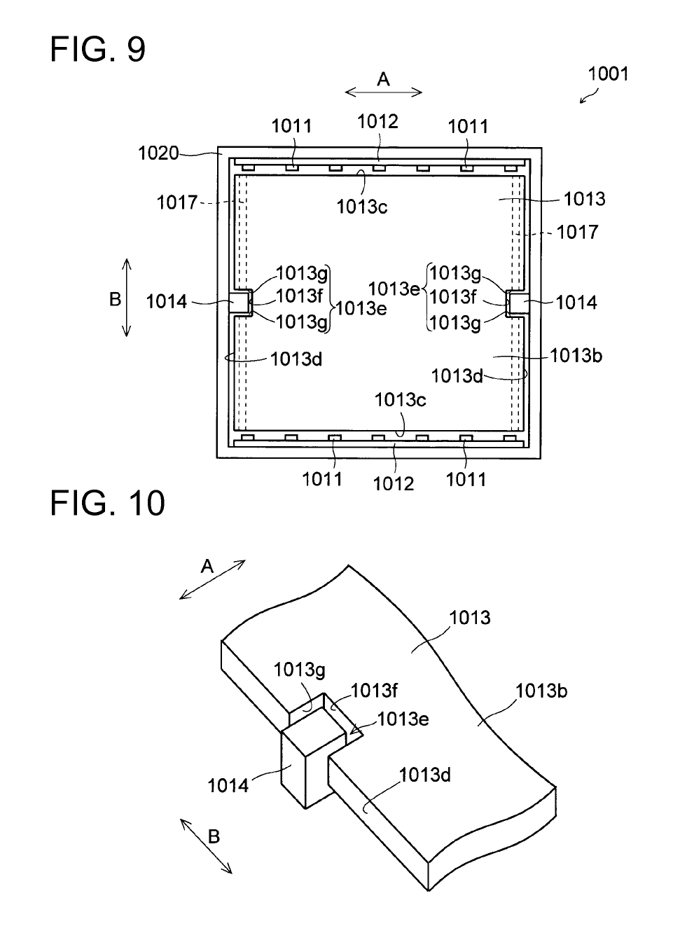

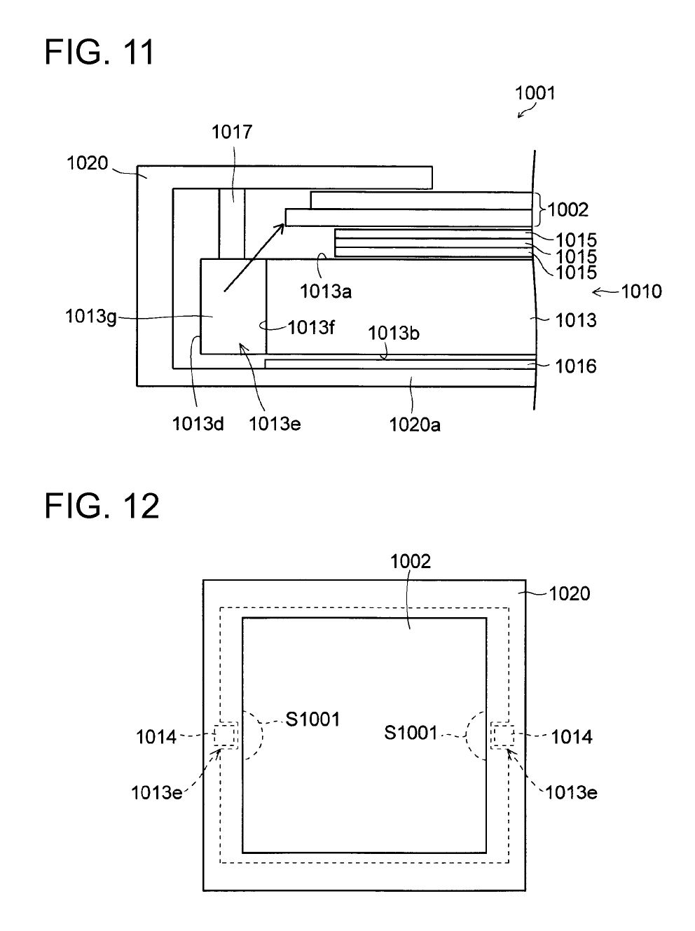

As shown in FIG. 7, a display device according to Embodiment 3 of the present invention has a plurality of light sources 11 arranged on opposing side faces 13d (light-entering faces) of a light guide plate 13, the light sources 11 being arrayed in the B direction with prescribed gaps therebetween. In other words, in Embodiment 3, of the four sides that form a rear surface 13b of the light guide plate 13, recessed portions 13e are formed in the sides (the side faces 13d) where the light sources 11 are arranged facing these sides. In a similar manner to Embodiments 1 and 2 described above, light that has leaked from the recessed portions 13e can be prevented from being directly incident on the end face of the display panel 2, and uneven brightness occurring in the display panel 2 can be suppressed. FIG. 7 shows a state in which a rear surface part 22 of a chassis 20 and a reflective sheet 16 have been removed.

Other structures and effects in Embodiment 3 are similar to Embodiment 1 described above.

The presently disclosed embodiments are wholly illustrative and not to be construed as limiting. The scope of the present invention is shown in the claims and not the embodiments described above, and in addition, all modifications within the equivalent meaning and scope of the claims are included.

In the embodiments described above, examples were shown of a display panel applied to a liquid crystal display panel, but the present invention is not limited thereto, and may be applied to a display panel other than a liquid crystal display panel, for example.

In the embodiments described above, a backlight device that illuminates a display panel was explained as one example of an illumination device, but the present invention is not limited thereto, and can also be applied to an illumination device that illuminates a member to be illuminated other than a display panel.

In the embodiments described above, the positioning members and chassis being made of metal was shown as an example, but the present invention is not limited thereto. The positioning members and chassis may be made of a resin, for example.

The ribs and positioning members may be formed by the chassis.

### DESCRIPTION OF REFERENCE CHARACTERS

1 display device
2 display panel (member to be illuminated)
10 illumination device
11 light source
13a light-exiting surface
13b rear surface
13e recessed portion
13f inner face (first inner face)
13g inner face (second inner face)
13h bottom surface
14 positioning member
17 rib
110 light-blocking layer L1 length (length of recessed portion in first direction) L2 length (length of side extending in first direction)

1. An illumination device, comprising:
light sources;
a light guide plate guiding light from the light sources; and
a positioning member positioning the light guide plate,
wherein the light guide plate includes a light-exiting surface where light exits towards a member to be illuminated, and a rear surface arranged on a side opposite to the light-exiting surface,
wherein a recessed portion is formed in an edge of the rear surface of the light guide plate, the recessed portion having a depth that does not reach the light-exiting surface, and
wherein the positioning member engages said recessed portion.

2. The illumination device according to claim 1,
wherein the rear surface of the light guide plate has four sides,
wherein the recessed portion is formed in a side of the four sides, said side extending in a first direction, and
wherein a length of the recessed portion in the first direction is shorter than a length of the side extending in the first direction.

3. The illumination device according to claim 1,
wherein the rear surface of the light guide plate has four sides,
wherein the light sources are arranged along a prescribed side of the four sides, and
wherein the recessed portion is formed in a side that intersects the prescribed side of the four sides.

4. The illumination device according to claim 1,
wherein the rear surface of the light guide plate has four sides, and
wherein the recessed portion is formed in at least two sides facing each other of the four sides.

5. The illumination device according to claim 1
wherein the rear surface of the light guide plate has four sides,
wherein the recessed portion is formed in a side of the four sides, said side extending in a first direction, and
wherein the recessed portion includes a first inner face extending in the first direction, a second inner face extending in a second direction that intersects the first direction, and a bottom surface intersecting the first inner face and the second inner face.

6. The illumination device according to claim 5,
wherein the light sources are arrayed along a prescribed direction, and
wherein a light-blocking layer is disposed on one of the first inner face and the second inner face that is parallel to an array direction of the light sources.

7. The illumination device according to claim 3,
wherein the light sources are arranged along at least two sides facing each other of the four sides,
wherein the recessed portion is formed in a side intersecting the two sides facing each other of the four sides, and
wherein the recessed portion is formed in a middle of the side intersecting the two sides facing each other.

8. The illumination device according to claim 1,
wherein the rear surface of the light guide plate has four sides,
wherein the recessed portion is formed in a side of the four sides, said side extending in a first direction,
wherein a light-blocking member is disposed on an edge of the light-exiting surface of the light guide plate in a vicinity of the side extending in the first direction, the light-blocking member extending in said first direction, and
wherein in a plan view the light-blocking member is arranged so as to overlap the positioning member.

9. A display device, comprising:
the illumination device according to claim 1; and
a display panel illuminated by the illumination device.

10. The display device according to claim 9, wherein a chassis having light-blocking characteristics is not arranged between the display panel and the light guide plate.
